(19) United States
(12) Patent Application Publication
(10) Pub. No.: US 2020/0255035 A1
(43) Pub. Date: Aug. 13, 2020

(54) Method and control unit for limiting an accident risk

(71) Applicant: Robert Bosch GmbH, Stuttgart (DE)

(72) Inventors: Erich Sonntag, Marbach Am Neckar (DE); Hans-Christian Swoboda, Grossbottwar (DE); Heiko Freienstein, Weil Der Stadt (DE); Johannes Ludwig Foltin, Ditzingen (DE); Joram Berger, Weissach (DE)

(21) Appl. No.: 16/781,650

(22) Filed: Feb. 4, 2020

(30) Foreign Application Priority Data
Feb. 13, 2019 (DE) 102019201888.2

(51) Int. Cl. B60W 60/00; G08G 1/16; G06K 9/00; G08G 1/01; H04W 4/46

(52) U.S. Cl. CPC B60W 60/0059; B60W 60/00272; B60W 60/0016; H04W 4/46; G06K 9/00838; G06K 9/00798; G08G 1/0133; G08G 1/162

(57) ABSTRACT

A method for limiting an accident risk. The method initially includes a step of identifying, in which an increased accident risk is identified due to a changed situation in the interior of a vehicle and/or a changed traffic situation in the surroundings of the vehicle. The method also includes a step of providing, in which a control signal is provided for activating the vehicle to change a driving style and/or a travel route and/or an interior parameter in response to the identified change of the situation in the of the vehicle and/or traffic situation in the surroundings of the vehicle, in order to limit the accident risk.

### CROSS REFERENCE

The present application claims the benefit under 35 U.S.C. § 119 of German Patent Application No. DE 102019201888.2 filed on Feb. 13, 2019, which is expressly incorporated herein by reference in its entirety.

### FIELD

The present invention is directed to a device and to a method for limiting an accident risk. The present invention is also directed to a computer program.

### BACKGROUND INFORMATION

An autopilot system for a vehicle, which automatically guides the vehicle transversely and/or longitudinally on an expressway, for example, takes a relative speed into account in such a way that the vehicle does not travel faster than, for example, 60 km/h past stationary objects and/or additional road users. In the case of warnings, for example, a traffic jam warning, a speed of the vehicle is reduced in order to dissipate less energy through braking and to thus come to a quicker stop upon a sudden appearance of the end of a traffic jam.

### SUMMARY

In accordance with the present invention, a method for limiting an accident risk, a control unit, which uses this method, and a corresponding computer program are provided. Advantageous refinements of and improvements on the device and method are described herein.

In accordance with the present invention, an increased accident risk of an autonomously driving vehicle due to a changed situation in the interior of the vehicle and/or to a changed traffic situation in the surroundings of the vehicle may be limited in that, for example, a driving style and/or a travel route and/or an interior parameter of the vehicle is changed in response to the identified change of the situation in the interior of the vehicle and/or of the traffic situation in the surroundings of the vehicle in such a way that occupant freedom as well as riding comfort are ensured.

An example method in accordance with the present invention is provided for limiting an accident risk, the example method including the following steps:

identifying an increased accident risk due to a changed situation in the interior of a vehicle and/or a changed traffic situation in the surroundings of the vehicle; and

providing a control signal for controlling the vehicle in order to change a driving style and/or a travel route and/or an interior parameter in response to the identified change of the situation in the interior of the vehicle and/or of the traffic situation in the surroundings of the vehicle, in order to limit an accident risk.

An accident risk may be understood to mean a probability, with which, for example, a vehicle traveling on an expressway encounters a danger or a drive of the vehicle on the expressway may have an adverse effect. Thus, an accident risk may further be understood to mean a danger of an accident. An increased danger of an accident in this case may be caused, for example, by a changed behavior of a vehicle occupant, for example, by an unbuckling of a safety belt and/or by a new seat position, in an unchanging traffic scenario. An increased danger of an accident may also be caused by an already existing interior situation and a new traffic situation for example, a traffic jam warning and/or increasing traffic density. In both cases, the danger of an accident is increased and the attempt may be made to compensate for it, for example, by a more defensive driving style of the vehicle. An interior situation may be understood to mean an event inside a vehicle, which may include a multitude of factors. An event in this case may, for example, be an adjusting of a seat position by a vehicle occupant and/or an unbuckling of a safety belt of a vehicle occupant. To be able to identify the changed interior situation, it is advantageous if a detection device is present in the vehicle, which may be implemented, for example, by sensors and/or camera units. Depending on the interior situation and/or the traffic situation in the surroundings of the vehicle, the vehicle may be able to react appropriately if it is no longer possible to ensure a sufficiently high degree of safety of the vehicle occupants. In this way, not only are the driver and other occupants of the vehicle protected, it is also possible as a result to increase a general traffic safety. By outputting a control signal, it is possible, for example, to change a driving style, a travel route and/or an interior parameter. Thus, a change of a driving style of the vehicle may, for example, be understood to mean the initiation of an acceleration operation or also a braking operation, a change of a travel route may, for example, be understood to mean a lane change of the vehicle and/or a changing of the travel route with respect to possibilities of necessary stopping on short notice. Finally, a change of an interior parameter may, for example, be understood to mean a change in a position of a seat device of the vehicle and/or an output of a warning to a vehicle occupant. A vehicle may be understood to mean a vehicle for transporting persons, for example, a highly autonomously driving vehicle. A vehicle may further be understood to mean a commercial vehicle for transporting persons and/or goods, for example, a highly autonomously driving truck or bus. A traffic situation may be understood to be an instantaneous traffic situation in the surroundings of a vehicle, which takes the vehicle density, traffic obstructions and/or the weather conditions on all traffic routes into account.

The advantages of the approach presented herein are, in particular, that in spite of a limitation of an accident risk of an autonomously driving vehicle with the aid of a change of a driving style and/or of a travel route and/or of an occupant parameter of the vehicle, occupant freedom as well as riding comfort may in the meantime be enhanced instead of being limited. According to the approach presented herein, an accident risk of the vehicle in this case may be sensorily monitored and the occupant may nevertheless be granted multiple freedoms in the event of a minimal danger of an accident, a vehicle occupant being able, for example, to select a seat position comfortable for him or her. Conversely, the vehicle occupant may influence a driving behavior of an autopilot by his/her behavior in the interior of the vehicle, the vehicle traveling slower, for example if the seat position selected by the vehicle occupant involves an increased risk of injury in a potential accident.

According to one specific embodiment, the changed vehicle interior situation may be identified in the step of identifying using a signal of an interior camera unit and/or a signal of a seat device, the signal of the seat device representing a changed seat adjustment of the seat device, in particular, a degree of an (imminent) injury severity of a vehicle occupant being determined in the step of identifying using the changed interior situation of the vehicle. A seat device may, for example, be an adjustable seat, a bench seat, a vehicle interior table and/or a holder in the interior in a vehicle. Thus, the interior of the vehicle and/or a vehicle occupant is observed, for example, using the interior camera unit and/or a seat adjustment of the vehicle occupant is monitored. In the process, it is possible to advantageously determine a potential injury severity of the vehicle occupant using the knowledge about a behavior and/or a seat position and/or a posture and/or a head position of the vehicle occupant. Such a specific embodiment of the approach presented herein further offers the advantage that a driving style, in particular, a speed of the vehicle may be changed and/or the distance of the vehicle to a preceding vehicle and/or to a following vehicle may be adapted with the aid of a determined injury severity in combination with an accident risk, in order to ensure the vehicle occupant the desired degree of freedom and in a timely manner to identify and avoid a potentially critical traffic situation.

According to a further specific embodiment of the represent invention, the method includes a step of ascertaining, in which a relative speed and/or a relative speed range is ascertained between the vehicle and at least one vehicle preceding the vehicle and/or at least one vehicle following the vehicle using a measured speed of the preceding and/or of the following vehicle, as well as a speed of the vehicle, the control signal being provided in the step of providing as a function of the ascertained relative speed and/or of the ascertained relative speed range. The information about the measured speed may be measured not only by an ego-vehicle itself, but also by another vehicle and/or by an infrastructure element such as a traffic flow sensor and may be provided via a radio interface. Such a specific embodiment of the approach presented herein offers the advantage, for example, that the vehicle may be controlled as a function of the level of the ascertained relative speed and/or of the size of the ascertained relative speed range, in such a way that a suitable measure may be taken in order to limit an accident risk of the vehicle and thus to increase a general traffic safety.

According to one specific embodiment of the present invention, a target speed of the vehicle may also be ascertained in the step of ascertaining for changing the vehicle interior situation and/or the traffic situation using the ascertained relative speed and/or the relative speed range, it further being checked in the step of ascertaining, in particular, whether the ascertained target speed of the vehicle is outside a relative speed threshold value, a driving style of the vehicle being changed in the step of providing by controlling the vehicle using the control signal in order to decelerate. A driving style may, for example, be related to the individual manner in which the driver or a driver assistance system or a pilot system drives the vehicle. For this purpose, the seat position and/or the posture of a driver during driving, for example, may be taken into account. Such a specific embodiment of the approach presented herein thus offers the advantage that an accident risk or a danger of an accident involving the vehicle may be lowered with the aid of a change of a driving style of the vehicle, for example, by reducing the speed of the vehicle, and thus a general traffic safety may be increased.

According to one specific embodiment of the present invention, the relative speed and/or the relative speed range of a vehicle driving in the direction of travel of the vehicle in a right and/or left lane in relation to the vehicle may also be ascertained in the step of ascertaining, the step of ascertaining being ascertained using a measured average speed of the vehicle driving in the right and/or left lane as well as a speed of the vehicle, a travel route of the vehicle being changed in the step of providing by activating the vehicle to change lanes using the control signal, the lane change being carried out, in particular, when the target speed of the vehicle is reached with the aid of a lane change. Such a specific embodiment of the approach presented herein also offers the advantage that an accident risk or a danger of an accident involving the vehicle may be lowered with the aid of a change of a travel route of the vehicle, for example, via a lane change of the vehicle, and thus a general traffic safety may be increased.

According to one specific embodiment of the present invention, the relative speed range may be increased in the step of ascertaining if a distance of the vehicle to at least one following vehicle and/or one preceding vehicle is greater than a predetermined distance threshold value and/or a predetermined time threshold value and/or if a range of a surroundings sensor of the vehicle is greater than a predetermined visual range threshold value. Thus, according to one specific embodiment, a continuous transition is also possible in this case between the relative speed ranges. Such a specific embodiment of the approach presented herein offers the advantage that the approach presented herein is flexibly designed, as a result of which the vehicle is able to advantageously adapt to a multitude of different traffic situations in the surroundings of the vehicle in order to limit an accident risk of the vehicle, to ensure a freedom of a vehicle occupant and to increase a general traffic safety. With a wide sensor range, for example, with good visibility, \acting in a timely manner may further be enabled and thus additional road users may also be considered when mitigating a potentially dangerous traffic situation.

In a further specific embodiment of the present invention, it is possible in the step of ascertaining to ascertain the relative speed and/or the relative speed range while taking a tolerance range into account, the tolerance range being predefined and/or being obtained from a map and/or being generated from surroundings data of the vehicle. In this case, the tolerance range for a lane may be taken into account when assigning a target speed of the vehicle. Thus, some vehicles may travel slower and other vehicles faster than the vehicle on the same lane. Therefore, it is not possible to deduce a speed of a vehicle following the vehicle based on the speed of a vehicle preceding the vehicle. Nor is it possible to assume that the vehicle preceding the vehicle is able to constantly maintain an instantaneous speed, since the preceding vehicle will potentially decelerate and/or even swerve due to a slower vehicle. Such a specific embodiment of the approach presented herein thus offers the advantage that critical and dangerous situations may be reported in a timely manner to the vehicle and/or to the driver using a vehicle-to-vehicle communication, which serves to exchange pieces of information and/or data between a plurality of vehicles and, as a result, the ascertained tolerance range may be reduced. It is further possible that a communication with an external server, on which, for example, map data from vehicle movement data are stored, may also take place. The data in the map may, for example, have been detected by other road users, but possibly also by infrastructure elements such as traffic monitoring cameras or speed control devices.

According to one specific embodiment of the present invention, the relative speed range may also be divided in the step of ascertaining of the relative speed range into an upper and lower relative speed range, the lower relative speed range being divided and/or changed while taking a speed of the fastest vehicle following the vehicle into account and the upper relative speed range being divided and/or changed while taking the speed of the slowest vehicle preceding the vehicle into account. It is possible using an ascertained relative speed range to determine a target speed and/or a target speed range of a vehicle in one lane. In the specific embodiment presented herein, this speed range is separated into the aforementioned upper and lower relative speed range. Such a specific embodiment of the approach presented herein thus offers the advantage that potential inaccuracies in the ascertainment of a target speed and/or a target speed range of a vehicle in one lane may be taken into account. In this way, the different speeds of the road users on one lane may also be taken into account, which is particularly advantageous in terms of limiting the accident risk.

According to a further specific embodiment of the present invention, the upper relative speed range may further be selected, in particular, taking a speed range of a vehicle traveling slower in the direction of travel of the vehicle in an adjacent lane into account. In this way, it may be advantageously ensured that when a vehicle cuts from an adjacent lane into the lane of the vehicle, even there the relative speed is sufficiently low such that the vehicle is able to react in a timely manner to the vehicle cutting in. This is, in particular, the case if, for example, the vehicle intends to switch from a left lane to the center lane and another vehicle intends to switch from the right lane to the center lane.

According to one specific embodiment of the present invention, an interior parameter may also be changed in the step of providing by using a control signal to activate a seat device, a vehicle interior table and/or a holder in the interior of the vehicle for an adjustment and/or by providing a visual, acoustic and/or haptic warning to a vehicle occupant, the interior parameter being changed, in particular, if a change of the driving style and/or of the travel route of the vehicle is not implementable within a predetermined time period. If a change of the driving style, for example, with the aid of a speed reduction of the vehicle and/or a change of the travel route, for example, with the aid of a lane change of the vehicle, is/are not implementable due to an excessively low relative speed range and/or to an excessively heavy traffic volume, then an interior parameter of the vehicle is changed. Thus, in this case a seat device of the vehicle may, for example, be automatically adjusted and/or an adjustment of a seat device may be inhibited. In addition, a piece of information and/or a warning may also be output to a vehicle occupant and/or the vehicle occupant may possibly even be prompted to assume the driving task him/herself. However, once an occupant is also included in an automated driving event, or if the interior of the vehicle is changed to be different from that desired by the vehicle occupant, it may be assumed that this is less accepted by the vehicle occupant than, for example, an adaptation of the driving style of the vehicle. Such a specific embodiment of the approach presented herein thus offers the advantage that a speed, and thus the driving style of the vehicle, is changed over a preferably long time period and while preserving a safety aspect, in order to allow the vehicle occupant as much freedom and comfort as possible.

Finally, the step of identifying and/or the step of providing may be carried out according to one specific embodiment in a vehicle-external processing unit and/or in a processing unit installed in the vehicle, the step of identifying and/or the step of providing, in particular, being carried out repeatedly. In this case, such a specific embodiment of the approach presented herein offers, for example, the advantage that a processing of data in a vehicle-external processing unit means a lower processing requirement in the vehicle itself and an associated lower power consumption, or allows for the possibility of utilizing resources for other functions. Moreover, the external processing unit has greater available computing power than a vehicle-internal computer.

The present invention further provides an example control unit, which is designed to carry out, activate or implement the steps of a variant of a method presented herein in corresponding units. With this embodiment variant of the present invention in the form of a control unit as well, it is possible to quickly and efficiently achieve the object underlying the present invention.

For this purpose, the control unit may include at least one processing unit for processing signals or data, at least one memory unit for storing signals or data, at least one interface to a sensor or to an actuator for reading in sensor signals from the sensor or for outputting control signals to the actuator and/or at least one communication interface for reading in or outputting data, which are embedded in a communication protocol. The processing unit may, for example, be a signal processor, a microcontroller or the like, the memory unit being capable of being a flash memory, an EEPROM or a magnetic memory unit. The communication interface may be designed to read in or output data wirelessly and/or in a hardwired manner, a communication interface able to read in or output hardwired data being capable of reading in these data, for example, electrically or optically from a corresponding data transmission line or outputting these data in a corresponding data transmission line.

A control unit may be understood in the present case to be an electrical device, which processes sensor signals and outputs control signals and/or data signals as a function thereof. The control unit may include an interface, which may be designed in hardware and/or in software. In a hardware design, the interfaces may, for example, be part of a so-called system ASIC, which contains a wide variety of functions of the device. It is also possible, however, for the interfaces to be dedicated integrated circuits or to be made up at least partly of discrete components. In a software design, the interfaces may be software modules, which are present, for example, on a microcontroller alongside other software modules.

In one advantageous embodiment, an activation of the vehicle takes place via the control unit to change a speed and/or to change a travel route and/or to change an interior parameter of the vehicle. For this purpose, the control unit may, for example, access input signals or sensor signals. The activation takes place via actuators such as, for example, an engine control for accelerating the vehicle or braking actuators for decelerating the vehicle. Alternatively or in addition, a steering actuator for changing the travel route or driving trajectory or a seat adjustment actuator for adjusting a seat position for a vehicle occupant may be activated.

Also advantageous in accordance with the present invention is an example computer program product or computer program having program code, which may be stored on a machine-readable medium or memory medium, such as a semiconductor memory, a hard disk memory or an optical memory, and which is used for carrying out, implementing and/or controlling the steps of the method according to one of the previously described specific embodiments, in particular, when the program product or program is executed on a computer or a device.

Exemplary embodiments of the present invention are depicted in the figures and explained in greater detail below.

### BRIEF DESCRIPTION OF THE FIGURES

FIG. 1 shows a block diagram of a control unit for activating a vehicle for limiting an accident risk according to one exemplary embodiment.

FIG. 2 schematically shows an overview of a traffic situation for using a method for limiting an accident risk according to one exemplary embodiment.

FIG. 3 schematically shows a representation of average driven vehicle speeds on an expressway according to one exemplary embodiment.

FIG. 4 schematically shows a representation of a change of speed of a vehicle for limiting an accident risk according to one exemplary embodiment.

FIG. 5 schematically shows a representation of a change of speed of a vehicle for limiting an accident risk according to one exemplary embodiment.

FIG. 6 schematically shows a representation of a change of speed of a vehicle for limiting an accident risk according to one exemplary embodiment.

FIG. 7 schematically shows a representation of a lane change of a vehicle for limiting an accident risk according to one exemplary embodiment.

FIG. 8 schematically shows a representation of a lane change of a vehicle for limiting an accident risk according to one exemplary embodiment.

FIG. 9 schematically shows a representation of expected relative speed ranges of vehicles on an expressway according to one exemplary embodiment.

FIG. 10 shows a flow chart of one exemplary embodiment of a method for limiting an accident risk according to one exemplary embodiment.

FIG. 11 shows a flow chart of one exemplary embodiment of a method for limiting an accident risk according to one exemplary embodiment.

### DETAILED DESCRIPTION OF EXAMPLE EMBODIMENTS

In the following description of preferred exemplary embodiments of the present invention, identical or similar reference numerals are used for elements which are represented in the various figures and act similarly, a repeated description of these elements being omitted.

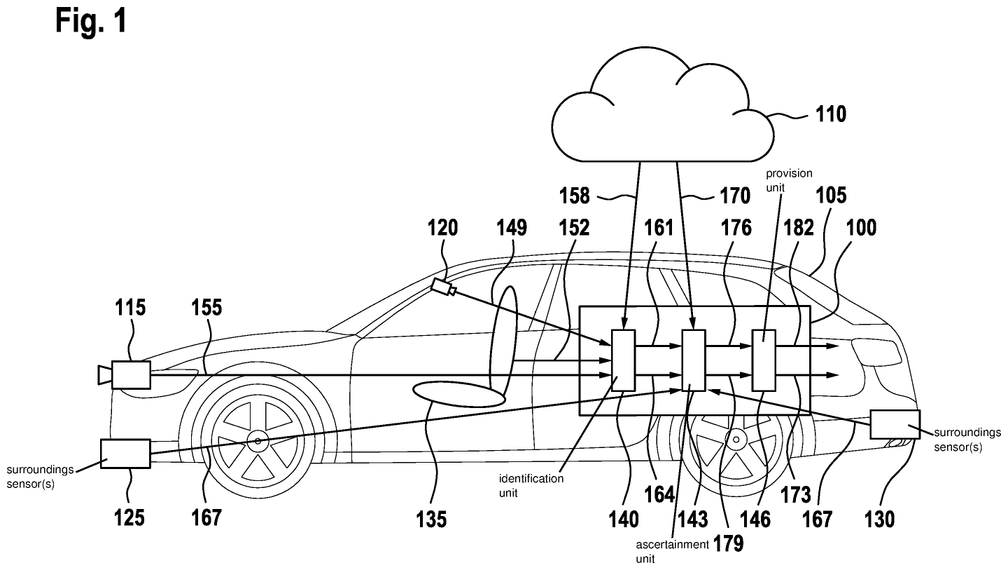

FIG. 1 shows a block diagram of a control unit 100 for activating a vehicle 105 for limiting an accident risk according to one exemplary embodiment. Control unit 100 in this case is situated, for example, in vehicle 105. In addition or alternatively, control unit 100 may also be situated in a vehicle-external processing unit 110. A control unit 100 may, for example, be understood to mean an electrical device, which processes sensor signals and outputs control signals and/or data signals as a function thereof. According to one exemplary embodiment, vehicle 105 includes a camera unit 115 for the visual-sensory detection of a surroundings of vehicle 105, as well as an interior camera unit 120 for the visual-sensory detection of an interior situation of vehicle 105. Vehicle 105 further includes at least two surroundings sensors 125 and 130, each of surroundings sensors 125 and 130 according to one exemplary embodiment being a radar sensor and/or a LIDAR sensor, which are used, in particular, for detecting a speed of additional road users. Finally, vehicle 105 according to one exemplary embodiment includes at least one seat device 135 for a vehicle occupant.

Control unit 100 according to one exemplary embodiment includes an identification unit 140, an ascertainment unit 143 as well as a provision unit 146. According to one exemplary embodiment, identification unit 140 is designed to identify an increased accident risk due to a changed interior situation of vehicle 105 and/or of a changed traffic situation in the surroundings of vehicle 105. In this case, the changed interior situation of vehicle 105 is identified, for example, using a signal 149 of interior camera unit 120, as well as a signal 152 of seat device 135, which represents a changed seat position of seat device 135. A changed traffic situation in the surroundings of vehicle 105 may be identified, for example, using a signal 155 of camera unit 115 of vehicle 105. In addition or alternatively, a piece of information 158 regarding a changed traffic situation in the surroundings of vehicle 105 may be provided by vehicle-external processing unit 115 and/or via a vehicle-to-vehicle communication interface to identification unit 140.

According to one exemplary embodiment, ascertainment unit 143 is designed to ascertain a relative speed and/or a relative speed range between vehicle 105 and at least one vehicle preceding vehicle 105 and/or at least one vehicle following vehicle 105 using a measured speed of the preceding vehicle and/or of the following vehicle, as well as a speed of vehicle 105 in response to an interior situation signal 161 and/or traffic situation signal 164 provided by identification unit 140. In this case, surroundings sensors 125 and 130 of vehicle 105 are designed to measure a speed of the at least one vehicle preceding and/or following vehicle 105 and to provide this information in each case in the form of a speed signal 167 to ascertainment unit 143. In addition or alternatively, the speed of the vehicle preceding and/or following vehicle 105 may be provided by vehicle-external processing unit 110 to ascertainment unit 143 using a vehicle-to-vehicle communication interface and/or with the aid of a piece of speed information 170.

Ascertainment unit 143 is further designed to ascertain a target speed of vehicle 105 using the ascertained relative speed and/or the relative speed range. In addition, ascertainment unit 143 is designed, for example, to check whether the ascertained speed of vehicle 105 is outside a relative speed threshold value.

According to one exemplary embodiment, ascertainment unit 143 is also or alternatively designed to ascertain the relative speed and/or the relative speed range of a vehicle traveling in a right and/or left lane in the direction of travel of vehicle 105. This is the case, for example, when vehicle 105 travels on an expressway and/or on a multi-lane roadway. In this case, ascertainment unit 143 is designed, for example, to ascertain the relative speed and/or the relative speed range of the vehicle traveling in the right and/or left lane in the direction of travel of vehicle 105 using a measured average speed of the vehicle traveling in the right and/or left lane, as well as a speed of vehicle 105. The average speed of the at least one vehicle in this case may be measured, for example, using surroundings sensors 125 and 130 of vehicle 105 and provided in each case to ascertainment unit 143 with the aid of speed signal 167.

According to one exemplary embodiment, provision unit 146 is designed to output a control signal 173 for activating vehicle 105, in order to change a driving style and/or a travel route and/or an interior parameter of vehicle 105 in response to the identified change of the situation in the interior of vehicle 105 and/or of the traffic situation in the surroundings of vehicle 105, in order to limit the accident risk. Thus, provision unit 146 in this case is further designed to provide control signal 173 as a function of relative speed 176 ascertained by ascertainment unit 143 and provided to provision unit 146 and/or of relative speed range 179 ascertained and provided to provision unit 146. According to one exemplary embodiment, a driving style of vehicle 105 may initially be changed using control signal 173 by activating vehicle 105 to decelerate using control signal 173. A travel route of vehicle 105 may subsequently be changed using control signal 173 by activating vehicle 105 to change lanes using control signal 173, the lane change being carried out, in particular, if the target speed of vehicle 105 is able to be reached with the aid of a lane change. Finally, an interior parameter of vehicle 105 may be changed using control signal 173, for example, by activating seat device 135 or additional interior furnishings not shown, such as a vehicle interior table and/or a holder in the interior of vehicle 105 for an adjustment, and/or by providing a visual, acoustic and/or haptic warning in the form of a warning signal 182 to a vehicle occupant. In this case, provision unit 146 is designed, in particular, to change the interior parameter if a change of the driving style and/or of the travel route of vehicle 105 is not implementable in a predetermined period of time.

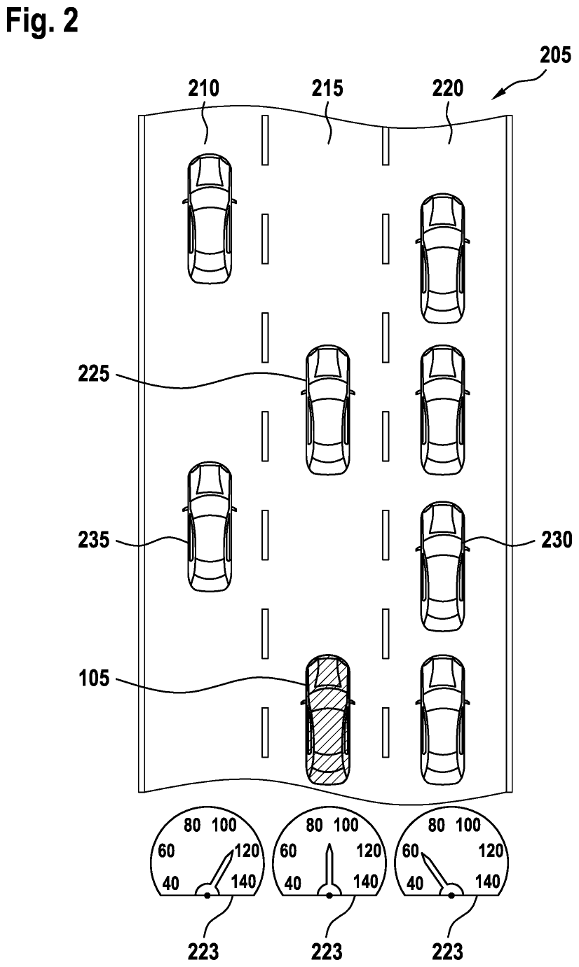

FIG. 2 schematically shows an overview of a traffic situation for using a method for limiting an accident risk according to one exemplary embodiment. Thus, an expressway 205, for example, is depicted in FIG. 2, expressway 205 including a left lane 210, a center lane 215 and a right lane 220. The associated speeds of the vehicles are displayed on one schematic tachometer 223 each in the lower portion of FIG. 2. In this case, the further to the left a lane 210, 215, 220 is situated on expressway 205, the higher the speed is that is traveled by the vehicles in this lane 210, 215, 220. Vehicle 105 according to one exemplary embodiment is traveling in center lane 215. In the traffic situation depicted herein, it is apparent that the vehicles are traveling under the drive-to-the-right rule, i.e., the vehicles in left lane 210 are traveling faster than the vehicles in center lane 215, and that the vehicles in center lane 215 are traveling faster than the vehicles in right lane 220. An average speed of the vehicles traveling in left lane 210 is 120 km/h, for example. An average speed of the vehicles traveling in center lane 215 is 90 km/h, for example. An average speed of the vehicles traveling in right lane 220 is 70 km/h, for example. Depending on the exemplary embodiment, right lane 220 may be fully occupied by vehicles, as is depicted in FIG. 2 or it may have gaps (not explicitly depicted).

In the traffic situation depicted, vehicle 105 is moving at an average speed of 90 km/h at a constant distance to a vehicle 225 preceding in the direction of travel of vehicle 105. If the speed of vehicle 105 is reduced due to a changed interior situation of vehicle 105, for example by a behavior of a vehicle occupant, a relative speed of vehicle 105 is subsequently increased as a result, in order to gain distance on preceding vehicle 225. If the distance between vehicle 105 and preceding vehicle 225 is too great, there is in turn the risk that an additional vehicle 230 or 235 traveling in right 220 and/or left 210 lane in the direction of travel of vehicle 105 will cut in and a distance of vehicle 105 to preceding vehicle 225 will suddenly be too short. This means, vehicle 105 merely keeping a distance to preceding vehicle 225 depending on the behavior of additional road users is not sufficient. Thus, a general reduction of the speed of vehicle 105 is necessary, but would, however, result in an increase in the relative speed as well as in an associated severity of a potential accident of vehicle 105.

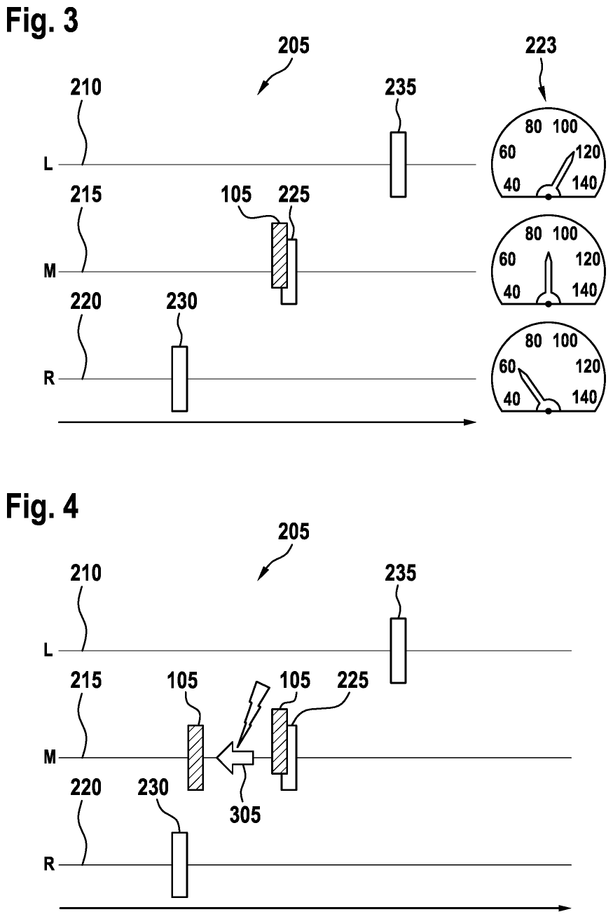

FIG. 3 schematically shows a representation of average driven vehicle speeds on an expressway 205 according to one specific embodiment. This is represented by the arrow shown on the x-axis of FIG. 3 for an increasing speed. L in this case represents a speed in left lane 210, M in this case represents a speed in center lane 215 and R in this case represents a speed in right lane 220 of expressway 205. The associated driven average speeds of the vehicles are displayed on one schematic tachometer 223 each in the right portion of FIG. 3. The dark bar according to one exemplary embodiment represents a speed of vehicle 105 traveling in center lane 215 (merely the reference numerals for the vehicles from FIG. 2 being used for the sake of recognizability, although the speeds are displayed in FIG. 3 and in the additional following figures). The light-colored bars according to one exemplary embodiment each represent at least one speed of vehicle 225 proceeding vehicle 105 in center lane 215, of at least vehicle 235 passing vehicle 105, which is traveling in left lane 210, and of at least vehicle 230, which is traveling in right lane 220. An average speed of vehicle 235 traveling in left lane 210 is 120 km/h, for example. An average speed of vehicles 105 and 225 traveling in center lane 215 is 90 km/h, for example. An average speed of vehicle 230 traveling in right lane 220 is 70 m/h, for example. Vehicle 105 in this case is traveling at the same speed as that of vehicle 225 preceding vehicle 105.

FIG. 4 schematically shows a representation of a change of speed of a vehicle 105 for limiting an accident risk according to one exemplary embodiment. L in this case represents a speed in left lane 210, M in this case represents a speed in center lane 215 and R in this case represents a speed in right lane 220 of expressway 205. The dark bar according to one exemplary embodiment represents a speed of vehicle 105 traveling in center lane 215. The light-colored bars according to one exemplary embodiment each represent at least one speed of vehicle 225 preceding vehicle 105 in center lane 215, of at least vehicle 235 passing vehicle 105, which is traveling in left lane 210, and of at least vehicle 230, which is traveling in right lane 220.

If an occupant of vehicle 105 then acts in the interior, i.e., for example, adjusts a seat device of vehicle 105, unbuckles and/or rotates counter to a direction of travel of vehicle 105, an interior situation of vehicle 105 changes and a potential accident risk of vehicle 105 increases. In this case, a driver assistance system of vehicle 105 will attempt to limit the potential accident risk with the aid of a change in the speed of vehicle 105. However changing the speed, in this case, reducing the speed, increases a relative speed of vehicle 105, in particular, relative to vehicle 225 preceding vehicle 105 in center lane 215 and, for example, to following road users not shown. Thus, the relative speed is increased (i.e., as is described) or reduced relative to preceding vehicle 225, though the relative speed relative to the other road users in the lane may also be increased. If, for example, vehicle 105 decelerates sharply, a potential impact energy on a stationary object is reduced or time is gained for reacting to a possible accident situation as a result of the change in speed. Thus, the situation improves relative to preceding vehicle 225 (i.e., a reduced accident risk is achieved).

Exactly the opposite is caused by the change of speed for the following traffic. The relative speed is increased as a result of the braking. Thus, if the following road user, not depicted in FIG. 2, does not notice the deceleration, an accident could then result. The relative speed relative to the following vehicle, and thus the possible crash impulse, has been increased as a result of the braking.

The approach described herein covers precisely the situation, in which it should be weighed to what extent the speed may be reduced in order to limit the accident risk to the front and, at the same time, not to allow the accident risk to the rear to become too great. In this case it is usually assumed in the description that a constant speed is traveled in one lane, i.e., a preceding vehicle 225, as well as a following vehicle, have the same speed.

This situation is depicted in FIG. 4 with the aid of a speed shifted to the left, i.e., that the speed of vehicle 105 is reduced. Vehicle 225 preceding vehicle 105 in center lane 215 would then have a higher speed than vehicle 105. Arrow 305 is intended to indicate that the left and right bars, which are correctly both identified as the speed of vehicle 105, belong to the same vehicle, but one before and one after speed reduction 305.

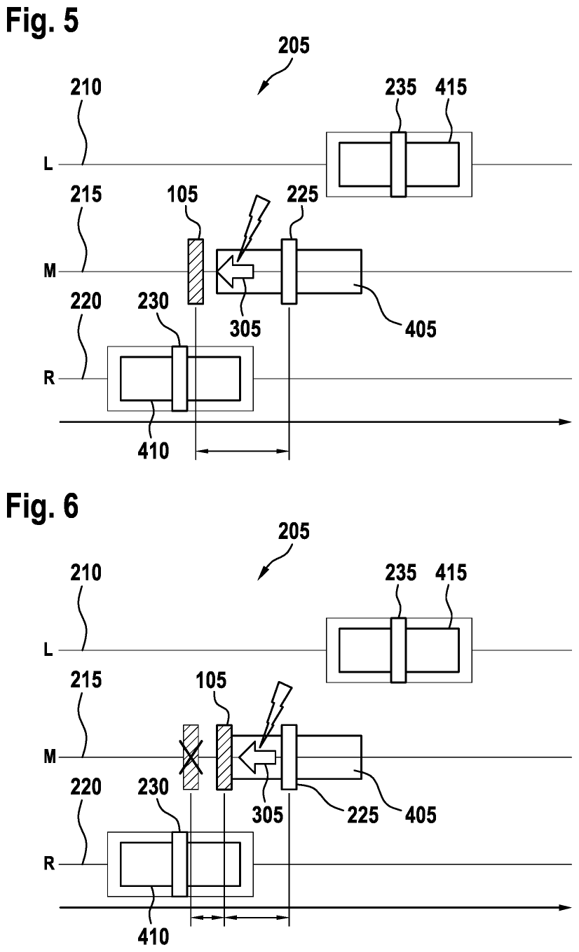

FIG. 5 schematically shows a representation of a change of speed of a vehicle 105 for limiting an accident risk according to one exemplary embodiment. L in this case represents left lane 210, M in this case represents center lane 215 and R in this case represents right lane 220 of expressway 205. The dark bar according to one exemplary embodiment represents the speed of vehicle 105, which is traveling in center lane 215. In the extreme case, light-colored bar 225 may even represent the speed of all vehicles in the lane (except for the ego-vehicle, the speed of which is marked by dark bar 105 in center lane 215). The light-colored bars according to one exemplary embodiment each represent at least one speed of vehicle 225 preceding vehicle 105 in center lane 215, of at least vehicle 235 passing vehicle 105, which is traveling in left lane 210, and of at least vehicle 230, which is traveling in right lane 220. A variant is also possible, in which light-colored bar 225 represents the speed of all vehicles, with the exception that preceding vehicle 225 has exactly this speed. The following road user, which is not shown in FIG. 2, would also have the speed of the light-colored bar.

Rectangular areas 405, 410 and 415 around vehicles 225, 230 and 235 each represent a relative speed range between vehicle 105 and vehicles 225, 230 and 235, in particular, relative speed range 405 between vehicle 105 and vehicle 225 preceding vehicle 105 (and the other vehicles in lanes 210, 215 and 220, which include, for example, vehicles 235, 225 and 230) being of importance, for example. Area 405 (and bar 405) in this case indicate the tolerated speed range, in which the relative speed is within a tolerable range. In this case, FIG. 5 illustrates with the aid of a speed marking 305 shifted to the left the problem that a relative speed of vehicle 105 is too high, which could result in an increased danger of an accident involving vehicle 105. Furthermore, the relative speed relative to the following road user (not shown) is equally relevant. For the purpose of protection, the speed is reduced and thus the relative speed relative to the preceding vehicle (and possibly slow vehicles cutting in) is improved, however, the relative speed relative to the following traffic or the following vehicles, in particular, is deteriorated as a result.

FIG. 6 schematically shows a representation of a change of speed of a vehicle 105 for limiting an accident risk according to one exemplary embodiment. L in this case represents left lane 210, M in this case represents center lane 215 and R in this case represents right lane 220 of expressway 205. The dark bar according to one exemplary embodiment represents a speed of vehicle 105 traveling in center lane 215. The light-colored bars according to one exemplary embodiment each represent at least vehicle 225 preceding vehicle 105 in center lane 215, at least vehicle 235 passing vehicle 105, which is traveling in left lane 210, and at least vehicle 230, which is traveling in right lane 220. Rectangular areas 405, 410 and 415 around vehicles 225, 230 and 235 each represent an ascertained relative speed range between vehicle 105 and vehicles 225, 230 and 235, in particular, relative speed range 405 between vehicle 105 and vehicle 225 preceding vehicle 105 being of importance.

If vehicle 105 were to adapt the speed to the changed interior situation, then the relative speed of vehicle 105 would be too high, which would result in an increased danger of an accident. Thus, a target speed of vehicle 105 is ascertained for limiting an accident risk using ascertained relative speed range 405 between vehicle 105 and vehicle 225 preceding vehicle 105, and it is further checked whether the target speed of vehicle 105 is outside a relative speed threshold range and vehicle 105 is subsequently decelerated up to a maximum of this speed. This speed reduction is depicted with the aid of a speed marking 305 shifted to the left. In the example depicted here, the relative speed of vehicle 105 is acceptable, since the target speed of vehicle 105 is still within relative speed range 405.

In FIG. 6, vehicle 105 is also shown in an alternative position (crossed-out) in center lane 215, in which a target speed of vehicle 105 would be so drastically changed or reduced due to a serious change of an interior situation of vehicle 105, for example, that the target speed of vehicle 105 would fall outside the relative speed threshold range, an accident involving a vehicle following vehicle 105 potentially occurring with increased probability. Since a change of the speed of vehicle 105 is therefore not implementable and/or advisable, a travel route of vehicle 105 and/or an interior situation of vehicle 105 should be changed in order to limit the accident risk.

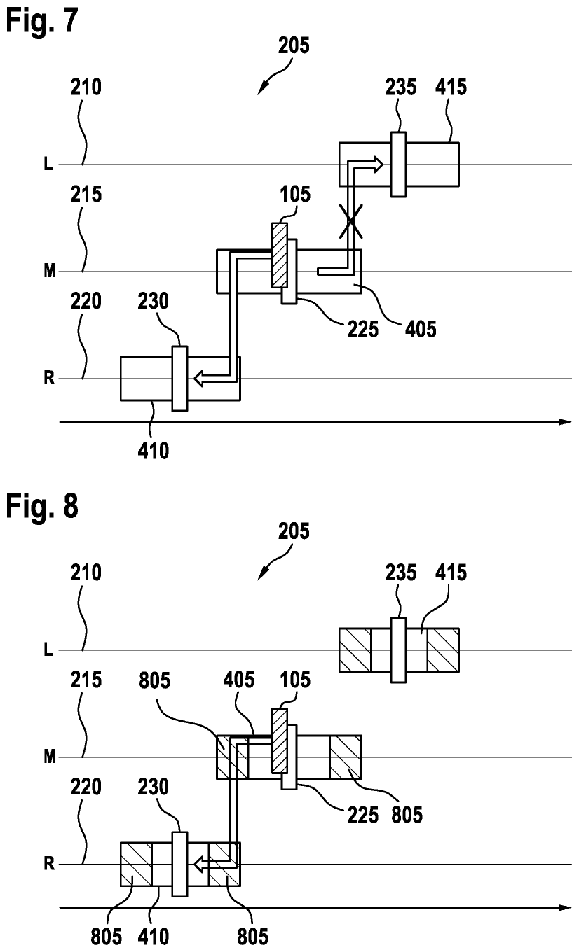

FIG. 7 schematically shows a representation of a lane change of a vehicle 105 for limiting an accident risk according to one exemplary embodiment. L in this case represents left lane 210, M in this case represents center lane 215 and R in this case represents right lane 220 of expressway 205. The dark bar according to one exemplary embodiment represents vehicle 105, which is traveling in center lane 215. The light-colored bars according to one exemplary embodiment each represent at least vehicle 225 preceding vehicle 105 in center lane 215, at least vehicle 235 passing vehicle 105, which is traveling in left lane 210, and at least vehicle 230, which is traveling in right lane 220. Rectangular areas 405, 410 and 415 around vehicles 225, 230 and 235 each represent an ascertained relative speed range between vehicle 105 and vehicles 225, 230 and 235. In this case the rectangular areas represent the speed range in which vehicle 105 is able to move in the relevant lane (L, M, R) and the accident risk remains within an acceptable range.

If a change of the driving style of vehicle 105, for example, a change of the speed as depicted in FIGS. 4, 5 and 6, is not implementable, since a speed of vehicle 105 would have to be too drastically reduced in order to limit the danger of an accident, vehicle 105 should change its travel route and carry out a lane change, for example. In this case, vehicle 105 would reduce its speed in center lane 215 until a lane change, preferably to right lane 220, is possible. In this way, vehicle 105 is able, due to the lane change, to reduce its speed at an acceptable relative speed, as a result of which the danger of an accident involving vehicle 105 in turn could be lowered.

A lane change of vehicle 105 from center lane 215 to left lane 210 at relative speed would also be possible here, however, an increase in the speed of vehicle 105 would not contribute to any reduction in the danger of an accident. Should a change of lane within a predetermined time window not be possible, then an interior situation of vehicle 105 should be changed, for example, with the aid of an adjustment of seat device of vehicle 105 and/or indirectly with the aid of an output of a warning to at least one vehicle occupant.

FIG. 8 schematically shows a representation of a lane change of a vehicle 105 for limiting an accident risk according to one exemplary embodiment. L in this case represents left lane 210, M in this case represents center lane 215 and R in this case represents right lane 220 of expressway 205. The dark bar according to one exemplary embodiment represents vehicle 105, which is traveling in center lane 215. The light-colored bars according to one exemplary embodiment each represent at least vehicle 225 preceding vehicle 105 in center lane 215, at least vehicle 235 passing vehicle 105, which is traveling in left lane 210, and at least vehicle 230, which is traveling in right lane 220. Rectangular areas 405, 410 and 415 around vehicles 225, 230 and 235 each represent an ascertained relative speed range between vehicle 105 and vehicles 225, 230 and 235.

According to one exemplary embodiment, a distance of vehicle 105 to vehicle 225 preceding vehicle 105 and/or to a vehicle following vehicle 105, as well as the general presence of vehicles on expressway 205 may be evaluated and taken into account in the approach presented herein for limiting an accident risk. Thus, for example, a lane change of vehicle 105 is enabled if the distance of vehicle 105 to potentially following vehicles in center lane 215 and in right lane 220 is greater than a predetermined distance threshold value and/or a predetermined time threshold value and/or if a range of at least one surroundings sensor of vehicle 105 is greater than a predetermined visual range threshold value and no following vehicles are detected in the visual range of the at least one surroundings sensor, and/or it is to be assumed that the visual range of other road users is greater than a predetermined visual range threshold value. As a result of the evaluation of the sensor visual range, the visual range of other road users may, for example, be estimated in order to assess whether the other road users have sufficient time to react to the slow ego-vehicle. Thus, an expanded relative speed range 805 is usable in the case of a long distance of vehicle 105 to following vehicles in center lane 215 and in right lane 220 and/or in the case of a high visual range of the at least one surroundings sensor of vehicle 105. Respective smaller relative speed range 405, 410 is utilized in the case of low visual range and/or of a short distance of vehicle 105 to following vehicles in center lane 215 and in right lane 220.

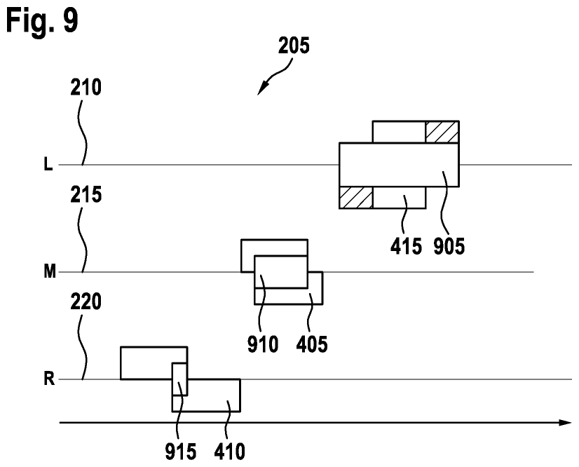

FIG. 9 schematically shows a representation of expected relative speed ranges of vehicles on an expressway according to one exemplary embodiment. In this case, relative speed ranges 405, 410, 415 of the vehicles are depicted in FIG. 9 as a function of the accuracy of a speed determination. L in this case represents left lane 210, M in this case represents center lane 215 and R in this case represents right lane 220 of expressway 205. The speed ranges represent the speed vehicle 105 is able to adopt with an acceptable accident risk. For example, if very fast vehicles and very slow vehicles appear in the same lane, the relative speed allowed to the slow vehicle (=minimum speed) is greater than if only slow vehicles are en route.

Dark bar 905 in left lane 210 according to one exemplary embodiment represents an average speed range in which, for example, the vehicles traveling in left lane 210 are moving. Dark bar 910 in center lane 215 according to one exemplary embodiment represents an average speed range in which, for example, the vehicles traveling in center lane 215 are moving. It is apparent here that speed range 905 is greater than speed range 910. Dark bar 915 in right lane 220 in one exemplary embodiment represents an average speed range in which, for example, the vehicles traveling in right lane 220 are moving. Accordingly, the vehicles in right lane 220 are traveling at virtually the same speed in FIG. 9. In this case, relative speed range 410, taking the speed fluctuations into account, corresponds approximately to relative speed range 410 from FIG. 7.

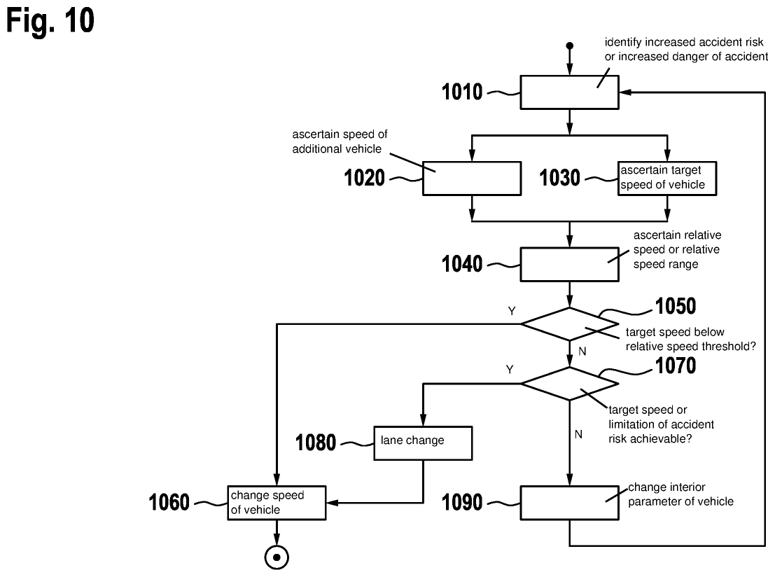

The speed of the vehicles in center lane 215 fluctuates, which may be seen in a broader speed range 910. A speed range 905, 910, 915 may be ascertained using an upper and lower relative speed range, the lower relative speed range being adapted, taking into account a speed of the fastest vehicle following vehicle 105 and the upper speed range being adapted taking into account the slowest vehicle preceding vehicle 105. This speed range has a narrower width in center lane 215 than in right lane 220 in order to be able to keep the danger of an accident from the relative speed constant in the case of fluctuating speed. Speed range 905 in left lane 210 is very large in FIG. 10. Because a fast vehicle in left lane 210 should be able to come to a timely stop and at the same time react to a slow traveling, suddenly appearing vehicle, resulting speed range 905 is smaller than average speed range 905 of the lane. This is indicated by the hatched area. However, the speed of following vehicles should be taken into account in this case when decelerating to a maximum speed.

FIG. 10 shows a flow diagram of a method for limiting an accident risk according to one exemplary embodiment.

According to one exemplary embodiment, an increased accident risk or an increased danger of an accident due to a changed interior situation of a vehicle, for example, because of a changed behavior of a vehicle occupant and/or due to a changed traffic situation, for example, because of an acute danger of congestion, is identified in the surroundings of the vehicle in a first process step 1010 of the method.

In a following process step 1020, a speed of at least one additional vehicle preceding and/or following the vehicle in the direction of travel of the vehicle is ascertained. In addition or alternatively, a speed of at least one additional vehicle is also ascertained, which is traveling in a left and/or right lane in relation to the vehicle. In a concurrent process step 1030, a target speed of the vehicle is ascertained, to which speed the vehicle should be activated to decelerate in order to limit an accident risk.

A relative speed and/or a relative speed range between the vehicle and the at least one preceding and/or the at least one following vehicle and/or the at least one additional vehicle, which is travelling in a left and/or right lane in relation to the vehicle, is ascertained in a process step 1040 using the speed measured in process step 1020 of at least one additional vehicle, which precedes and/or follows the vehicle in the direction of travel of the vehicle and/or of at least one additional vehicle, which is traveling in a left and/or right lane in relation to the vehicle, and also using an instantaneous speed of the vehicle.

In a first decision step 1050, the question then arises whether the target speed of the vehicle is below a relative speed threshold value. If so, a process step 1060 follows, in which a speed of the vehicle is changed in such a way that an accident risk of the vehicle is limited. This represents the ideal case. In the case of small speed differences (i.e., at a low relative speed) the speed may be directly adapted.

If no, a decision step 1070 follows, in which the question then arises whether the target speed of the vehicle or a limitation of the accident risk of the vehicle may be achieved with the aid of a lane change of the vehicle. If so, a process step 1080 follows, in which the lane change takes place with a subsequent change of speed of the vehicle. If decision step 1070 is answered with no, a process step 1090 follows, in which an interior parameter of the vehicle is changed in such a way that an accident risk of the vehicle is limited.

Once process step 1090 is carried out, it is then possible according to one exemplary embodiment to jump back to process step 1010.

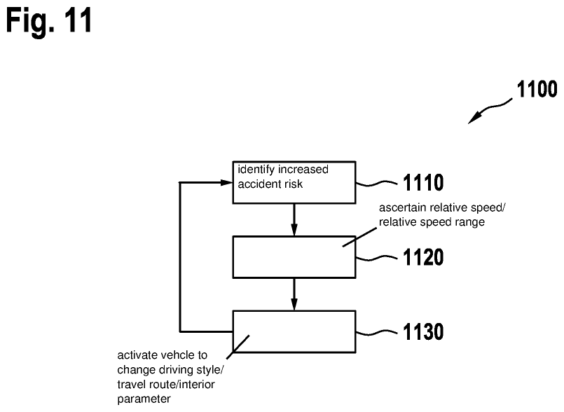

FIG. 11 shows a flow chart of one exemplary embodiment of a method 1100 for limiting an accident risk according to one exemplary embodiment. In this case, method 1100 may be carried out, for example, on the control unit for limiting an accident risk from FIG. 1.

In a step 1110 of method 1100, an increased accident risk is identified due to a changed interior situation of a vehicle and/or a changed traffic situation in the surroundings of the vehicle. Subsequently, method 1100 includes a step 1120, in which a relative speed and/or a relative speed range is ascertained between the vehicle and a preceding and/or following vehicle and/or of a vehicle traveling in a right and/or left lane in the direction of travel of the vehicle using a measured speed of the vehicle preceding and/or following and/or travelling in the right and/or left lane in the direction of travel of the vehicle, as well as a speed of the vehicle. Finally, method 1100 includes a step 1130, in which a control signal is provided for activating the vehicle in order to change a driving style and/or a travel route and/or an interior parameter of the vehicle in response to the identified change in the interior situation of the vehicle and/or traffic situation in the surroundings of the vehicle, in order to limit the accident risk.

According to one exemplary embodiment, step 1110 and/or step 1130 of method 1100 is/are carried out repeatedly.

If an exemplary embodiment includes an “and/or” linkage between a first feature and a second feature, this is to be read in the sense that the exemplary embodiment according to one specific embodiment includes both the first feature and the second feature, and according to another specific embodiment, either only the first feature or only the second feature.

1-13. (canceled)

14. A method for limiting an accident risk, the method comprising the following steps:
identifying an increased accident risk due to a changed situation in an interior of a vehicle and/or a changed traffic situation in surroundings of the vehicle; and
providing, in response to the identifying of the increased accident risk due to the changed situation in the interior of the vehicle and/or the changed traffic situation in the surroundings of the vehicle, a control signal for controlling the vehicle to change a driving style of the vehicle, and/or a travel route of the vehicle, and/or an interior parameter of the vehicle, to limit an accident risk.

15. The method as recited in claim 14, wherein in the identifying step, the changed situation in the vehicle interior is identified using: (i) a signal of an interior camera unit, and/or (ii) a signal of a seat device, the signal of the seat device representing a changed seat adjustment of the seat device.

16. The method as recited in claim 15, wherein in the identifying step, a degree of an imminent injury severity of a vehicle occupant is determined using the changed situation in the interior of the vehicle.

17. The method as recited in claim 14, further comprising the following step:
ascertaining a relative speed and/or a relative speed range, between the vehicle and a preceding and/or following vehicle, using a measured speed of the preceding and/or the following vehicle and a speed of the vehicle, the control signal being provided in the providing step as a function of the ascertained relative speed and/or of the ascertained relative speed range.

18. The method as recited in claim 17, wherein in the ascertaining step, a target speed of the vehicle is ascertained for changing the situation in the vehicle interior and/or the traffic situation using the ascertained relative speed and/or the relative speed range, and wherein the ascertaining step including checking whether the ascertained target speed is outside a relative speed threshold value, a driving style of the vehicle being changed in the providing step by activating the vehicle to decelerate using the control signal.

19. The method as recited in claim 18, wherein preceding and/or following vehicle is a vehicle traveling in a direction of travel of the vehicle in a right and/or left lane in relation to the vehicle, the relative speed and/or the relative speed range being ascertained using a measured average speed of the vehicle traveling in the right and/or left lane and the speed of the vehicle, a travel route of the vehicle being changed in the providing step by activating the vehicle to change lanes using the control signal.

20. The method as recited in claim 19, wherein the lane change is carried out if the target speed of the vehicle is reached using the lane change.

21. The method as recited in claim 17, wherein in the ascertaining step, the relative speed range is increased: (i) if a distance of the vehicle to at least one vehicle following the vehicle and/or to at least one vehicle preceding the vehicle is greater than a predetermined distance threshold value, and/or (ii) if a range of a surroundings sensor of the vehicle is greater than a predetermined visual range threshold value.

22. The method as recited in claim 17, wherein in the ascertaining step, the relative speed and/or the relative speed range is ascertained taking a tolerance range into account, the tolerance range being: (i) predefined, and/or (ii) obtained from a map, and/or (iii) generated from surroundings data of the vehicle.

23. The method as recited in claim 22, wherein the tolerance range is reduced using a vehicle-to-vehicle communication.

24. The method as recited in claim 17, wherein in the ascertaining step, the relative speed range is ascertained, the relative speed range being divided into an upper relative speed range and a lower relative speed range, the lower relative speed range being divided and/or changed taking a speed of a fastest vehicle following the vehicle into account and the upper relative speed range being divided and/or changed taking a slowest vehicle preceding the vehicle into account.

25. The method as recited in claim 14, wherein in the providing step, an interior parameter is changed using the signal to activate: (i) an adjustment of a seat device, and/or (ii) an adjustment of a vehicle interior space table, and/or (ii) an adjustment of a holder in the interior of the vehicle.

26. The method as recited in claim 14, wherein in the providing step: a visual warning and/or an acoustic warning, and/or a haptic warning, is provided to a vehicle occupant.

27. The method as recited in claim 14, wherein the interior parameter is changed when the change of the driving style and/or the change of the travel route of the vehicle, is not implementable within a predetermined period of time.

28. The method as recited in claim 14, wherein the identifying step and/or the providing step, is carried out in a vehicle-external processing unit and/or in a processing unit installed in the vehicle.

29. The method as recited in claim 14, wherein the identifying and/or the providing step are carried out repeatedly.

30. A control unit configured to limit an accident risk, the control unit configured to:
identify an increased accident risk due to a changed situation in an interior of a vehicle and/or a changed traffic situation in surroundings of the vehicle; and
provide, in response to the identifying of the increased accident risk due to the changed situation in the interior of the vehicle and/or the changed traffic situation in the surroundings of the vehicle, a control signal for controlling the vehicle to change a driving style of the vehicle, and/or a travel route of the vehicle, and/or an interior parameter of the vehicle, to limit an accident risk.

31. A non-transitory machine-readable memory medium on which is stored a computer program for limiting an accident risk, the computer program, when executed by a computer, causing the computer to perform the following steps:
identifying an increased accident risk due to a changed situation in an interior of a vehicle and/or a changed traffic situation in surroundings of the vehicle; and
providing, in response to the identifying of the increased accident risk due to the changed situation in the interior of the vehicle and/or the changed traffic situation in the surroundings of the vehicle, a control signal for controlling the vehicle to change a driving style of the vehicle, and/or a travel route of the vehicle, and/or an interior parameter of the vehicle, to limit an accident risk.
